(19) United States
(12) Patent Application Publication
(10) Pub. No.: US 2010/0133380 A1
(43) Pub. Date: Jun. 3, 2010

(54) SKIN PANEL FOR AN AIRCRAFT FUSELAGE

(76) Inventors: Geerardus Hubertus Joannes Jozeph Roebroeks, Den Bommel (NL); Jan Willem Gunnink, Ijssel (NL); Erik Jan Kroon, Rotterdam (NL)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/440,574

(22) PCT Filed: Aug. 24, 2007
(86) PCT No.: PCT/NL07/50418

§ 371 Date: Jan. 12, 2010

(30) Foreign Application Priority Data
Sep. 12, 2006 (NL) 2000232

(51) Int. Cl. B64C 1/12; B32B 15/14

(52) U.S. Cl. 244/119; 428/608; 244/133; 414/800

(57) ABSTRACT

The invention relates to a skin panel (11) of an aircraft (1), comprising a laminate of at least one first metal sheet (40) and preferably first fiber-reinforced polymer layers (41) connected thereto. The skin panel (11) is connected to stiffening elements (4) made of a laminate of second metal sheets (40) and second fiber-reinforced polymer layers (41) connected thereto, provided that the second fiber-reinforced polymer layer comprises fibers having a modulus of elasticity in tension of greater than 110 GPa. The invention also relates to an aircraft or spacecraft provided with such skin sheets.

The invention relates to a skin panel of an aircraft, comprising a laminate of at least one metal sheet. The invention furthermore comprises the application of such a skin panel in an aircraft or spacecraft, in particular the fuselage thereof. More particularly, the invention relates to a skin panel of an aircraft, comprising a laminate of at least one metal sheet and a fiber-reinforced polymer layer connected thereto.

Moldings made of a laminate of at least one metal sheet and at least one fiber-reinforced polymer layer connected thereto (hereinafter referred to as a metal laminate, fiber metal laminate or laminate for short) are increasingly used in industries such as the transportation industry, for example in cars, trains, aircraft and spacecraft. Such laminates can for example be used in the wings, fuselage and tail panels and/or other skin panels for aircraft, and generally ensure an improved fatigue resistance of the aircraft component. Furthermore, fiber metal laminates are lighter than for example aluminum, thus saving weight and in turn fuel.

The known fiber metal laminate is constructed of a large number of relatively thin (typically 0.2 mm to 0.4 mm thick) aluminum sheets with polymer adhesive layers reinforced with aramid fibers (Arall®) or high strength glass fibers (Glare®) in-between. This means that the fiber volume content in the adhesive layers is relatively high with typical values of approximately 50 volume-% for Arall® and 60 volume-% for Glare®. Although the known fiber laminate demonstrates good fatigue properties, it is disadvantageous in that the stiffness thereof is low compared with the usual aluminum alloys. If the known fiber laminate is used for example in the upper side of an aircraft fuselage, and aluminum in the lower side thereof, this can bring about an increase in load in the aluminum part. This part then has to be thickened, which means that the weight advantage achieved by applying the fiber metal laminate is at least partially lost. Another known possibility is to increase the number of layers of the fiber metal laminate in those places where the stress in the upper side of the fuselage is higher than average. However, this also leads to an increase in weight. There is therefore a need to increase the stiffness of skin sheets made of fiber metal laminate used in aircraft and spacecraft, and in particular to increase stiffness in the longitudinal direction of the fuselage of an aircraft or spacecraft, without this leading to a significant increase in weight.

The object of the invention is to provide a skin panel of the type referred to in the preamble, that can be used to meet the high requirements set by the aviation and space industry more effectively, and that inter alia does not have the disadvantages referred to above or only to a lesser extent.

The skin panel according to the invention is thereto characterized as referred to in claim 1. A skin panel according to the invention is characterized in particular in that it comprises a laminate of at least one first metal sheet, and preferably at least one first metal sheet and first fiber-reinforced polymer layers connected thereto, whereby the skin panel is also provided with at least one stiffening element comprising a laminate of two metal sheets and second fiber-reinforced polymer layers connected thereto, provided that the second fiber-reinforced polymer layer comprises fibers having a modulus of elasticity in tension that exceeds 110 GPa. It turns out that applying such a skin panel in the fuselage of an aircraft not only leads to lowering the load in aluminum parts of the fuselage, as already described above, but also reduces the average load in the fiber metal laminate of the skin panel itself. This creates an additional possibility for saving weight and furthermore increases the damage tolerance of the skin panel. It is also possible, depending on the working loads, to optimally select the position of the at least one stiffening element. It is thus possible for example to select the direction in which the at least one stiffening element extends according to the main direction(s) of tension in the skin panel. This is rendered more difficult if, for example, the number of layers in the fiber metal laminate is increased to absorb a higher load. A further advantage of the skin panel according to the invention is that it makes it possible to select properties of the at least one stiffening element that are different to the properties of the laminate of the skin panel. It is thus possible for example to select a second fiber-reinforced polymer layer with a lower specific gravity than the first fiber-reinforced polymer layer, so that additional weight savings can be generated. It is advantageous if the skin panel according to the invention is characterized in that the second fiber-reinforced polymer layer comprises fibers having a modulus of elasticity in tension of greater than 140 GPa, and more preferably greater than 250 GPa. The advantages referred to above are achieved to a greater extent in this preferred variant thanks to the further increase in stiffness. It should be noted that the use of carbon fibers in both the first and the second fiber-reinforced polymer layer is explicitly excluded. These carbon fibers do not provide the properties required within the scope of the invention.

In a preferred embodiment of the skin panel according to the invention, the skin panel is characterized in that the second fiber-reinforced polymer layer comprises fibers having a ratio of the modulus of elasticity in compression to the modulus of elasticity in tension of less than 0.8. This ratio is more preferably less than 0.6, and even more preferably less than 0.4. Such fibers apparently demonstrate the property that their modulus of elasticity in tension sharply increases with the elongation. Fibers to be suitably applied in the laminate according to the invention are drawn thermoplastic polymer fibers, aramid fibers (Kevlar®), poly(p-phenylene-2, 6-benzobisoxazole) fibers (PBO, Zylon®), poly(2,6-diimidazo-(4,5b-4′,5′e)pyridinylene-1,4(2,5-dihydroxy)phenylene) fibers (better known as M5® fibers), and ultrahigh molecular weight polyethylene or polypropylene fibers, boron fibers and/or combinations of the above fibers. The laminate according to the invention is preferably characterized in that the second fiber-reinforced polymer layer comprises fibers formed out of polymers selected from the group of aromatic polyamides (aramids), poly(p-phenylene-2,6-benzobisoxazole) (PBO), boron and M5, and even more preferably from the group of poly(p-phenylene-2,6-benzobisoxazole) (PBO) and boron. Although particularly favorable properties are obtained with the reinforcing fibers referred to above, reinforcing fibers with a relatively high tensile strength and/or stiffness can also be applied in the second fiber-reinforced polymer layer, possibly in combination, on the basis of glass, such as preferably S glass fibers. It should be noted that boron fibers are also understood to mean carbon and/or metal fibers that are provided with a layer of boron.

A particularly advantageous skin panel according to the invention is characterized in that when the stiffening element is in an unloaded state, a compressive stress is present on average in each second metal sheet and a tensile stress is present on average in each second fiber-reinforced polymer layer. It should be noted that the presence of a tensile stress in the second fiber-reinforced polymer layer does not mean that this layer only demonstrates tensile stresses. Rather a tensile stress prevails according to the invention on average in a specific direction. This direction corresponds with the direction of draw described within the scope of the method described below for obtaining such a stiffening element. The average tensile stress prevailing in this direction in the second polymer layer gives rise to an average compressive stress in the same direction in the metal sheets of the stiffening element. To derive maximum advantage from using the stiffening element, the direction of draw will preferably extend almost in a fiber direction of the second fiber-reinforced layer. Because stiffening elements for a skin panel of an aircraft fuselage are generally elongated in shape, the direction of draw is preferably about parallel to the longitudinal direction of the stiffening element.

According to the invention, the state of stress in the stiffening element is obtained by imposing an elongation thereon in a lengthwise direction (preferably the longitudinal direction), that is greater than the elastic elongation of the metal sheets and less than the elongation at break of the second fiber-reinforced polymer layer. Because the imposed elongation is greater than the elastic elongation limit of the metal sheets, the metal will undergo a plastic deformation. When the elongation is removed, the stiffening element springs back, but only partially on account of the plastic deformation. The extent of the permanent elongation in the stiffening element therefore determines the extent of the average compressive stress in the metal sheets and the average tensile stress in the fiber-reinforced polymer layers. The stiffening element can be pre-stressed or pre-drawn in a variety of ways according to the invention. For instance it is possible to pre-stress the stiffening element by subjecting it to a tensile force in a pulling device. In a preferred embodiment, an elongation is imposed on the stiffening element by feeding it through a rolling mill under pressure. Pre-stressing in this way is advantageous in that it can be performed continuously at a high feed-through speed. It is also possible to use this preferred method to pre-stress a stiffening element with a tapered thickness.

A preferred embodiment of the skin panel according to the invention is characterized in that the stiffening element is obtained by applying a method whereby at least two second metal sheets are connected to at least one intermediary second fiber-reinforced polymer layer, whereby after the connection thereof, the strip-shaped structure thus obtained is formed into a three-dimensional profile, and whereby an elongation is imposed in a lengthwise direction on the structure thus obtained, such elongation being greater than the elastic elongation of the metal sheets and less than the elongation at break of the fiber-reinforced polymer layer. By drawing the stiffening element, a stiffening element is obtained with increased stiffness compared to the non-drawn stiffening element. Furthermore, the state of stress thus applied in the stiffening element increases the crack tolerance of the skin panel. A further advantage of the present preferred variant of the skin panel is that it is possible to achieve a high stiffness without it being necessary to pre-draw the entire skin panel. Although the skin panel according to the invention can be pre-drawn if required, pre-drawing entire skin sheets with high stiffness fibers is a complicated process and generally does not lead to the desired result. To drawn entire skin sheets, they are clamped into position in very stiff steel clamping jaws and drawn. The sheets are provided with reinforcing tabs on both sides to reduce the chance of any breakage when being clamped into position and are then subjected to an elongation that is greater than the elastic elongation limit of the metal sheets. The drawing process per se can typically be carried out with an accuracy of ±0.05%. This means that for a set (permanent) elongation of 0.4% for example, the actual permanent elongation will vary from 0.35% to 0.45%. Because the actual permanent elongation will not be distributed homogeneously over the surface of the skin panel, and furthermore because transverse contraction inter alia is hindered at the level of the clamping, the actual elongation values will generally vary from approx. 0.28% to approx. 0.61%. This means that the properties of the fiber metal laminate of the skin panel will also display such a variation, which is not optimal. The skin panel according to the invention does not have this disadvantage.

A further preferred variant of the skin panel according to the invention is characterized in that the stiffening element is obtained by applying a method whereby at least two second metal sheets are connected to at least one intermediary second fiber-reinforced polymer layer, whereby after the connection thereof, an elongation is imposed in a lengthwise direction on the strip-shaped structure thus obtained, such elongation being greater than the elastic elongation of the metal sheets and less than the elongation at break of the second fiber-reinforced polymer layer, and whereby the structure thus obtained is formed into a three-dimensional profile. By pre-drawing the stiffening element in the form of a strip in this preferred variant, until a stiffness of preferably at least 80 GPa is achieved, a skin panel is obtained that not only demonstrates a higher stiffness and damage tolerance, it also has a significantly lower spread in properties than a pre-drawn skin panel. Drawing flat and relatively narrow strips (for example in the order of size of at least 100 mm wide) is a relatively simple process and can be carried out with a considerably lower tolerance than the tolerance of ±0.05% referred to above. Furthermore, the set elongation will be distributed more homogeneously over the relatively narrow strip. It is also possible to cut away the areas with clamping effects for narrow strips without this causing too much waste. According to the invention, the stiffening element in the form of a strip can be adhered to the fiber metal laminate of the skin panel. However, the stiffening element in the form of the pre-drawn strip is preferably further formed into a three-dimensional profile. When it is in this form, the stiffening element is also referred to as a “longitudinal stiffener”. A longitudinal stiffener formed in this way has the additional advantage in that the stiffness of the skin panel is further increased. To achieve the same increase in stiffness, it is necessary to use strips with a relatively large cross-section. To effectively stiffen the fuselage of an aircraft using strips, these strips can easily constitute up to at least 20% of the total cross-section of the fuselage skin This leads to a relatively large increase in weight and use of space. In this way, stiffening elements in the form of strips can impede the positioning of sufficient nails in the skin-truss connection of the fuselage. By forming the stiffening element as a longitudinal stiffener, this can be prevented. A longitudinal stiffener with a three-dimensionally formed cross-section can be formed in any known way by means of a strip-shaped stiffening element. For example this can be done by squaring a strip-shaped stiffening element in a molding tool suitable for this purpose. By repeating this process several times, it is possible in principle to form any conceivable cross-section. Another particularly suitable stiffening element comprises a metal sheet integrally provided with stiffening ribs and at least one second fiber-reinforced polymer layer. Such a stiffening element preferably comprises an extruded aluminum sheet, referred to as an “extrusion” by the person skilled in the art. Such extrusions comprise a flat sheet part substantially provided with stiffening elements, said sheet part being obtained by extruding a tubular form and then cutting it open, straightening and milling it and if desired pre-treating it for adhesion.

The at least one stiffening element can in principle be connected to the laminate of the skin panel in any conceivable way. It is thus possible for example to attach the stiffening element to the laminate using bolt connections. A particularly suitable method comprises adhering a stiffening element to the laminate of the skin panel by means of an adhesive layer made of an adhesive material suitable for this purpose. In a further preferred embodiment of a skin panel according to the invention, the stiffening element is connected to the skin panel by means of an adhesive layer comprising a fiber-reinforced polymer. A particularly suitable skin panel according to the invention is characterized in that the at least one stiffening element is connected to the laminate by at least one fiber-reinforced polymer layer having a reduced fiber volume content of at most 45 volume-%. This preferred variant of the skin panel demonstrates a further increase in damage tolerance and in particular an improved resistance to delamination. A further preferred embodiment of the skin panel according to the invention is characterized in that the fiber volume content of the specified fiber-reinforced polymer layer is at most 39 volume-%, more preferably at most 34 volume-%, and most preferably at most 30 volume-%. Such fiber volume contents are lower than the contents usually applied in fiber-reinforced polymers. When reference is made in this application to a fiber-reinforced polymer layer having a reduced fiber volume content, it is understood to be a layer having a fiber volume content of at most 45 volume-%, preferably at most 39 volume-%, more preferably at most 34 volume-%, and most preferably at most 30 volume-%. The fiber-reinforced polymer layer having a reduced fiber volume content can for example be obtained by using a semi-finished product in which the fibers in the specified volume content are impregnated with a suitable polymer in a partially cured state (referred to as prepregs). It is also possible to combine a prepreg having a usual fiber volume content of 60 volume-% for example, with one or more polymer adhesive layers, in order to achieve an average reduced fiber volume content. In such a case, an adhesive layer is preferably applied that is provided with a carrier, for example in the form of a network of polymer fibers, for example polyamid fibers. The carrier ensures that the adhesive layer retains a specific, pre-set thickness even after adhesion and curing. This is also advantageous for resistance to delamination. It is also possible according to the invention to combine dry—i.e. non-impregnated—fibers with a polymer adhesive layer in the appropriate volume ratios.

It is advantageous to characterize the skin panel according to the invention by comprising the first metal sheets and/or the first fiber-reinforced polymer layers in the laminate out of a material that is different to the second metal sheets and/or second fiber-reinforced polymer layers. In this way it is possible to set the properties of the metal sheets and/or fiber-reinforced polymer layers in such a way that they are optimal for the function required in the skin panel. For example it turns out to be advantageous if the second fiber-reinforced polymer layer in the stiffening element positioned closest to the laminate has a reduced fiber volume content.

The thickness of the first metal sheets in the laminate and of the second metal sheets in the stiffening element can be selected from a wide range. The thickness of the first metal sheets is preferably less than 3.0 mm, and more preferably between 0.3 and 0.6 mm inclusive, whereby different sheets can have different thicknesses if required. Using thinner metal sheets is favorable for the properties per se, but generally entails greater cost. The skin panel according to the invention is additionally advantageous in that thicker metal sheets that are between 0.6 and 0.8 mm thick for example do not necessarily lead to poorer properties. The thickness of the second metal sheets is preferably between 0.2 and 1.0 mm inclusive, more preferably between 0.2 and 0.6 mm inclusive, and most preferably between 0.2 and 0.4 mm inclusive, whereby different sheets can have different thicknesses if required.

The fiber-reinforced polymers applied in the fiber metal laminate and stiffening element of the skin panel are light and strong and comprise reinforcing fibers embedded in a polymer. The polymer also acts as a bonding means between the various layers. Reinforcing fibers that are suitable for use in the first fiber-reinforced polymer layers include for example glass fibers and/or metal fibers, and if required can also include drawn thermoplastic polymer fibers, such as aramid fibers, PBO fibers (Zylon®), M5® fibers, and ultrahigh molecular weight polyethylene or polypropylene fibers, as well as natural fibers such as flax, wood and hemp fibers, and/or combinations of the above fibers. It is also possible to use commingled and/or intermingled rovings. Such rovings comprise a reinforcing fiber and a thermoplastic polymer in fiber form. Examples of suitable matrix materials for the reinforcing fibers of the first and second fiber-reinforced polymer layers are thermoplastic polymers such as polyamides, polyimides, polyethersulphones, polyetheretherketone, polyurethanes, polyethylene, polypropylene, polyphenylene sulphides (PPS), polyamide-imides, acrylonitrile butadiene styrene (ABS), styrene/maleic anhydride (SMA), polycarbonate, polyphenylene oxide blend (PPO), thermoplastic polyesters such as polyethylene terephthalate, polybutylene terephthalate, as well as mixtures and copolymers of one or more of the above polymers. The preferred thermoplastic polymers further comprise an almost amorphous thermoplastic polymer having a glass transition temperature T_{g} of greater than 140° C., preferably greater than 160° C., such as polyarylate (PAR), polysulphone (PSO), polyethersulphone (PES), polyetherimide (PEI) or polyphenylene ether (PPE), and in particular poly-2,6 dimethyl phenylene ether. According to the invention, it is also possible to apply a semicrystalline or paracrystalline thermoplastic polymer having a crystalline melting point Tₘ of greater than 170° C., preferably greater than 270° C., such as polyphenylene sulphide (PPS), polyetherketones, in particular polyetheretherketone (PEEK), polyetherketone (PEK) and polyetherketoneketone (PEKK), “liquid crystal polymers” such as XYDAR by Dartco derived from monomers biphenol, terephthalic acid and hydrobenzoic acid. Suitable matrix materials also comprise thermosetting polymers such as epoxies, unsaturated polyester resins, melamine/formaldehyde resins, phenol/formaldehyde resins, polyurethanes, etcetera. If required, the first as well as the second fiber-reinforced polymer layers can comprise more than one type of fiber and/or matrix material.

In the skin panel according to the invention, it is preferable for the fiber-reinforced polymer layers to comprise substantially continuous fibers that mainly extend in one direction (so-called UD material). It is advantageous to use the fiber-reinforced polymer in the form of a pre-impregnated semi-finished product. Such a “prepreg” shows generally good mechanical properties after it has been cured, among other reasons because the fibers have already been wetted in advance by the matrix polymer. In a preferred embodiment of the skin panel according to the invention, at least a part of the first fiber-reinforced polymer layers substantially comprises two groups of continuous fibers extending in parallel, the directions of which run substantially perpendicular to each other. Such a stack of prepregs is also referred to by the person skilled in the art as “cross-ply”.

The fiber metal laminate and/or the stiffening element can be obtained according to the invention by connecting a number of metal sheets and intermediary fiber-reinforced polymer layers to each other by heating them under pressure and then cooling them. If desired, the fiber metal laminate and/or reinforcing element obtained in this way can be pre-drawn to achieve a favorable state of stress, as already explained above in detail. The stiffening elements are preferably adhered to the fiber metal laminate through the medium of an adhesive layer, preferably in the form of a fiber-reinforced polymer layer having a reduced fiber volume content. Adhesion can be implemented in a known way by providing the surfaces to be connected with a suitable adhesive and then curing this adhesive at least partially at a suitable temperature.

Metals that are particularly appropriate to use in the skin panel according to the invention include light metals, in particular aluminum alloys, such as aluminum copper and/or aluminum zinc and/or aluminum lithium alloys, or titanium alloys. The metal sheets preferably composed of an aluminum alloy can be selected according to the invention from the following group of aluminum alloys, such as types AA(USA) No. 2024, AA(USA) No. 7075, AA(USA) No. 7085, AA(USA) No. 7475 and/or AA(USA) No. 6013. In other respects, the invention is not restricted to laminates using these metals, so that if desired other aluminum alloys and/or for example steel or another suitable structural metal can be used.

A particularly favorable embodiment of the skin panel according to the invention comprises metal sheets, at least a part of which comprises an aluminum-lithium alloy. Such alloys increase the shearing stiffness of the laminate and/or the stiffening element. Yet another preferred embodiment comprises a laminate with metal sheets, at least a part of which comprises an aluminum-magnesium-scandium alloy. Such alloys continue to enhance resistance to corrosion, and are used in particular in the first metal sheets.

Depending on the intended use and requirements set, the optimum number of metal sheets can easily be determined by the person skilled in the art. The invention is not restricted to laminates having a specific number of metal sheets. Although the stiffening element according to the invention is particularly suitable for skin panels comprising a fiber metal laminate, it should be explicitly noted here that an assembly of a skin panel comprising a metal, and in particular comprising aluminum alloys, and at least one stiffening element according to the invention also forms part of the present invention. In this respect it should be noted that, if required, the skin panel made of metal can comprise more than one metal sheet interconnected by means of an adhesive film and/or fiber-reinforced polymer layer, and/or fiber-reinforced polymer layer having a reduced fiber volume content. Such a structure of the skin can be found for example around doors and windows in the fuselage, where a local increase in stress occurs and the skin therefore has to be thickened.

The invention also comprises an aircraft or spacecraft, the fuselage of which is wholly or partially constructed out of skin sheets according to the invention. Skin sheets for aircraft fuselages, etcetera, are generally more or less rectangular in shape and are applied on a framework of ribs extending in the longitudinal direction of the fuselage and perpendicular thereto. A skin panel according to the invention is advantageously characterized in that the fibers of the first fiber-reinforced polymer layer extend about parallel to the one side of the rectangle and in that the fibers of the second fiber-reinforced polymer layer extend about parallel to the other side of the rectangle of the sheet. It should be noted here that the skin panel can be flat in design but it can also incorporate a single or double curve, which is possible for example by laminating it on a correspondingly shaped mold.

According to a preferred variant, the at least one stiffening element extends only over part of the surface of the laminate of the skin panel, for example in the form of substantially rectangular strips and/or longitudinal stiffeners that extend more or less in parallel to the longitudinal direction of the fuselage. According to the invention, a skin panel for the fuselage of an aircraft or spacecraft is preferably formed of a laminate that is structured symmetrically from outside to inside of at least one metal sheet and at least two first fiber-reinforced polymer layers, with the thickness of the metal sheets being between 0.1 and 0.5 mm. The fuselage of an aircraft or spacecraft according to the invention is preferably provided with such skin sheets, such that the fibers of the first fiber-reinforced polymer layer extend substantially in the peripheral direction of the fuselage and the fibers of the second fiber-reinforced polymer layer extend substantially in the longitudinal direction of the fuselage. In this way, a fuselage is obtained with exceptionally good properties. A fuselage for an aircraft can be obtained using the skin sheets according to the invention, said fuselage demonstrating good fatigue properties in the cross and longitudinal direction of the fuselage, high strength in the peripheral direction of the fuselage and increased resistance to buckling at a lower surface weight (kg/m²). It should be noted that a fuselage provided with more than one stiffening element according to the invention extending in different directions also forms part of the invention.

Further features of the invention will emerge from the following schematic figures, without otherwise being restricted thereto. The following are shown:

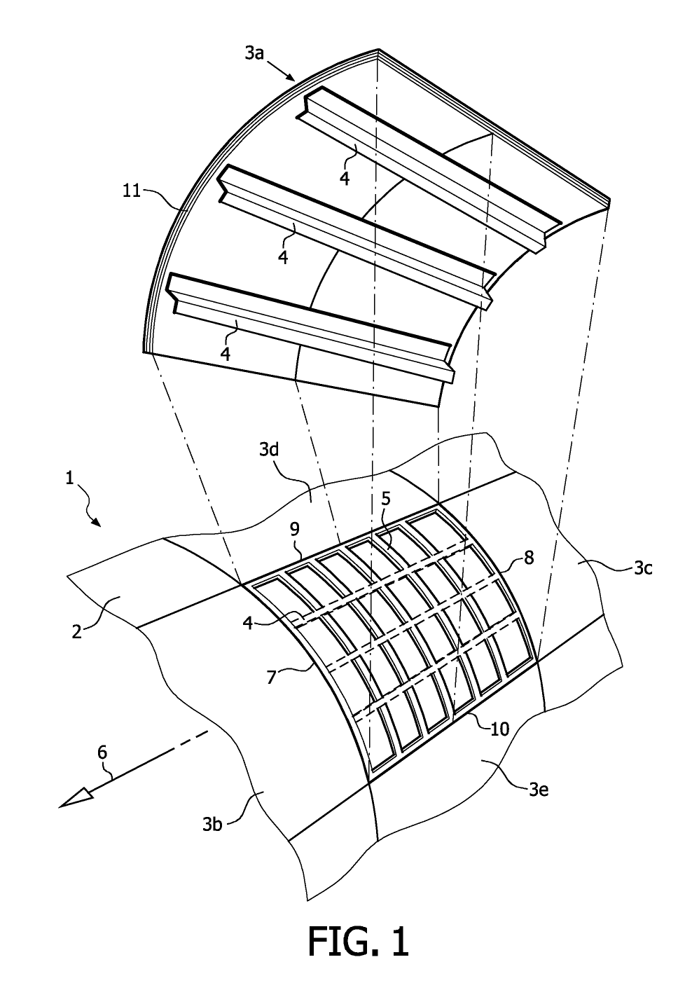

FIG. 1 shows a part of an aircraft fuselage in a cut-away view, provided with skin sheets according to the invention,

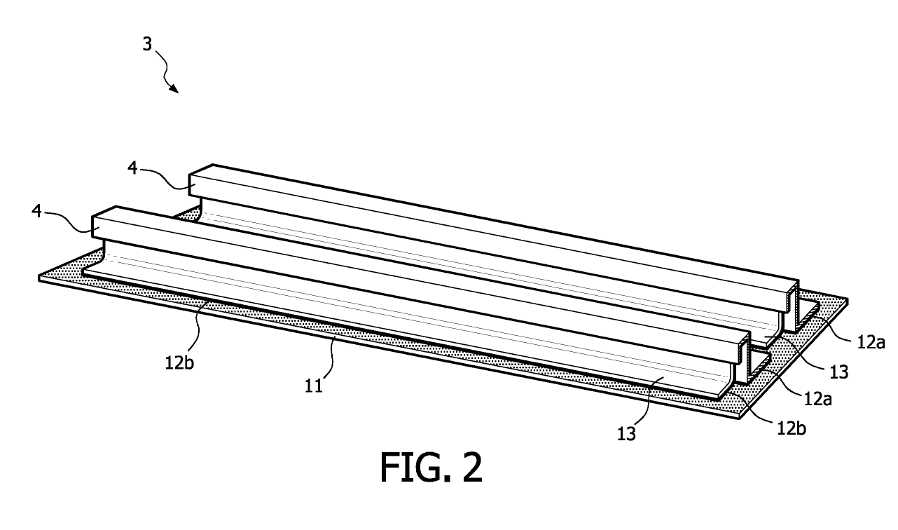

FIG. 2 shows a part of a skin panel provided with longitudinal stiffeners according to the invention,

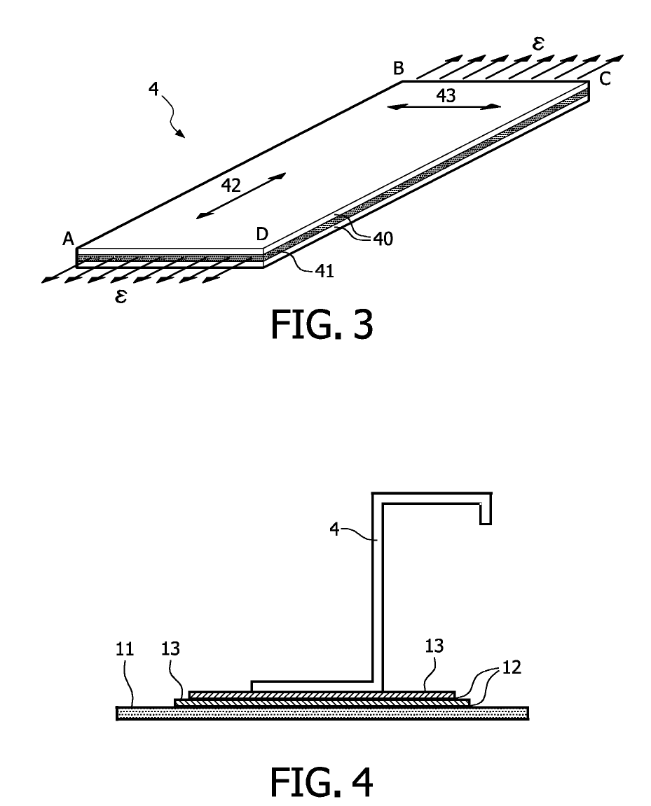

FIG. 3 shows an embodiment of a stiffening element according to the invention in the form of a pre-drawn strip,

FIG. 4 shows another embodiment of a longitudinal stiffener according to the invention obtained from the stiffening element shown in FIG. 3, and

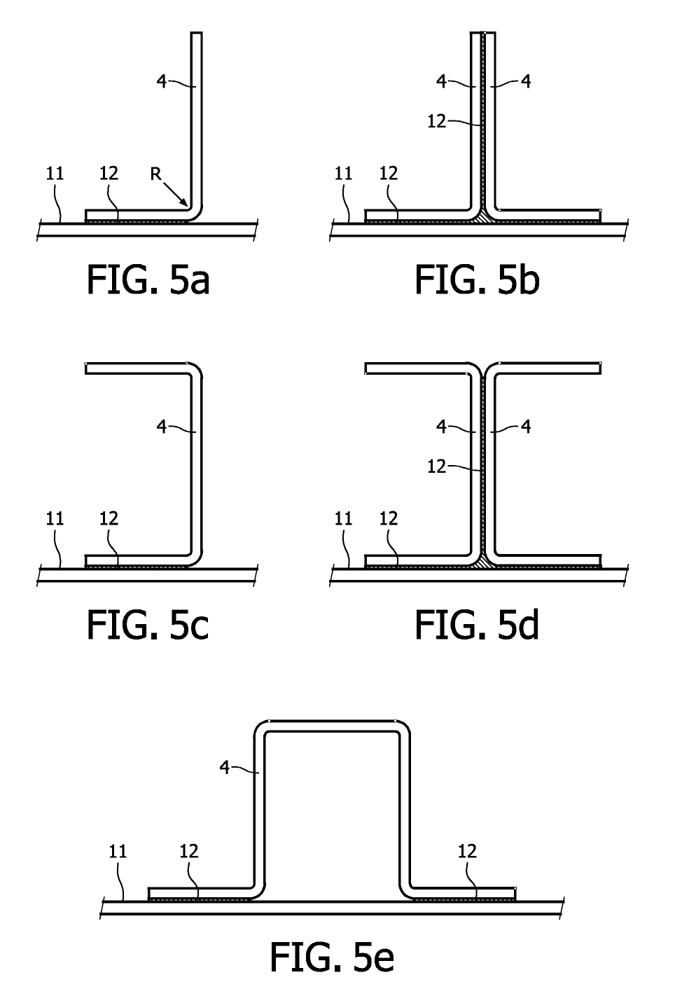

FIG. 5 shows a number of preferred embodiments of a skin panel according to the invention.

FIG. 1 shows a part of an aircraft 1, provided with a fuselage 2 that is produced out of a number of skin sheets 3 according to the invention. The skin sheets 3 are provided with a number of longitudinal stiffeners 4 (also referred to in the industry as “stringers”), that extend substantially parallel to the sides of the skin panel 3 running in the longitudinal direction 6 of the fuselage. Fuselage 2 comprises a number of cross ribs 5 running in the peripheral direction thereof. These ribs are more or less curved according to the curving desired in the fuselage 2. A skin panel 3 provided with longitudinal stiffeners 4 is attached to the cross ribs 5 by means of connections suitable for this purpose and known per se (not shown in detail). This creates a framework of interconnected longitudinal stiffeners 4 and cross ribs 5, as shown in FIG. 1, whereby the longitudinal stiffeners 4 are supported by the cross ribs 5. In FIG. 1, the longitudinal stiffeners 4 are shown in the framework by a dotted line, to indicate that the longitudinal stiffeners 4 form part of the skin panel 3, and only form part of the framework once the skin sheets 3 have been positioned. The skin sheets 3 are affixed to each other with a substantially close fit. In this way, FIG. 1 shows that a first skin panel 3a lies adjacent to a second skin panel 3b along a lateral joint seam 7. Similarly, the first skin panel 3a lies adjacent to a third skin panel 3c along a lateral joint seam 8. Laterally adjacent skin panels can be interconnected by means of an underlying strip, that is attached to both panels by means of for example three rows of rivets (not shown), although other means of connection are also possible. Furthermore, a fourth and fifth skin panel (3d, 3e) lie adjacent to the first skin panel 3a along longitudinal joints (9, 10) respectively. The skin panels can be connected in the longitudinal direction with a partially overlapping edge (for example with an overlap of 75 mm) by means of three rows of rivets (not shown), although here too other means of connection are possible. Skin panel 3 comprises a skin sheet 11 made of Glare® fiber metal laminate based on S-glass fibers. It is also possible, however, for the skin panel 3 to comprise a skin sheet 11 made of a metal, preferably aluminum.

FIG. 2 shows a detail of a skin panel 3 according to the invention, provided with 2 longitudinal stiffeners 4. The longitudinal stiffeners 4 can for example be affixed to the skin sheet 11 of skin panel 3 by means of an intermediary adhesive layer 12. To apply the adhesive, skin sheet 11 is pre-treated in a known way if required. The adhesive layer can in principle comprise any suitable adhesive. A particular suitable type of adhesive comprises epoxy adhesives, for example type AF 163-2 K, available from 3M. As shown in FIG. 2, the connection between the longitudinal stiffeners 4 and the skin sheet 11 can be reinforced if required by applying two Glare® glass fiber laminates 13, as shown in FIG. 2 through the medium of an adhesive layer 12b, that uses the same adhesive as adhesive layer 12a if required. However, it is not at all necessary for the invention to apply this additional reinforcement. If required, the assembly of skin sheet 11 and stiffening elements 4 can be placed in an autoclave at a high pressure and under pressure, to cure the adhesive layers (12a, 12b) and bring about the connection between skin sheet 11 and stiffening elements 4.

FIG. 3 shows an embodiment of a stiffening element 4 according to the invention in the form of a flat rectangular sheet or strip. In the embodiment shown, the stiffening element 4 is constructed out of a number of second metal sheets 40 having a thickness of for example 0.2 mm, comprising an aluminum alloy, for example 2024-T3. The second metal sheets 40 are securely interconnected by means of a second fiber-reinforced polymer layer 41 based on an epoxy resin that is also a good metal adhesive. The fiber-reinforced connecting layer 41 comprises and is formed of PBO fibers impregnated with the specified polymer, having a fiber volume content of approximately 50 vol.-%. These preimpregnated prepregs 41 with a thickness of approximately 0.25 mm are formed of (unidirectional) PBO fibers extending parallel to each other in direction 42. The strip-shaped stiffening element 4 is produced in a first step by applying the specified layers 40 and 41 to each other in the sequence shown in FIG. 3, for example on a flat mold. After lamination, the overall structure is cured at a temperature suitable for the epoxy resin. For most applications, an epoxy resin with a high glass transition temperature will be most suitable. Such epoxy resins are generally cured at a temperature of approximately 120° C. or approximately 175° C. After curing, residual compressive stresses generally form in the fiber-reinforced polymer layers and residual tensile stresses in the aluminum sheets of the fiber metal laminate. This state of stress is reversed according to the invention by drawing the fiber metal laminate until it reaches the plastic area of the metal, in particular aluminum. When the tensile load applied to this end is removed, the fibers that are substantially elastically deformed during the drawing process return to their original length, while the plastically extended aluminum offers resistance hereto. In this way, the fibers of the fiber-reinforced polymer layer on average are subjected to a tensile stress and the aluminum to a compressive stress, whereby the stress system in metal sheets and fiber-reinforced polymer layers is substantially in equilibrium. With reference to FIG. 3, after the structure shown therein has been cured, an elongation £ is imposed in the structure's lengthwise direction (direction 42), such elongation being greater than the elastic elongation of the second metal sheets 40 and less than the elongation at break of the second fiber-reinforced polymer layer 41. The applied elongation £ leads to a permanent elongation of between 0.1 and 2 percent for example (the actual elongation imposed is greater) once the load has been removed. Depending on the fibers applied in the second fiber-reinforced polymer layer, the range of this permanent elongation can also lie elsewhere. For instance, a permanent elongation will preferably lie between 0.2 and 1.4 percent, and more particularly between 0.3 and 0.7 percent. The average elongation ε to be imposed on the stiffening element in the method according to the invention can easily be determined by the person skilled in the art. It should also be noted that in principle it is possible to impose an elongation ε in an arbitrary longitudinal direction of the stiffening element 4. For instance, an elongation £ can be imposed parallel to the short side BC of the stiffening element 4 shown in FIG. 3, or at an angle to this short side. It is however advantageous to impose the elongation in the direction of the long side AB of the stiffening element 4 shown in FIG. 3, because this long side AB runs parallel to the fiber direction 42 of the second fiber-reinforced polymer. It is furthermore advantageous to pre-stress the stiffening element 4 by feeding it through a rolling mill under pressure. In such a preferred method, the stiffening element is fed in a continuous fashion in the form of a continuous sheet and pressurized. A method is thus provided that can be applied on an industrial scale, whereby a suitable device can comprise for example at least one set of cylindrical rollers arranged one above the other or across from each other between which the stiffening element 4 can be guided. By setting the exerted compressive force at a sufficiently high level, the deformations in the plane of the stiffening element are of such a size that the imposed elongation £ in the lengthwise direction exceeds the plasticity limit of the metal of the second metal sheets 40, causing the second metal sheet or sheets 40 to permanently deform, without leading to a failure of the second fiber-reinforced polymer layer or layers 41. By drawing the stiffening element 4 in the lengthwise direction, a particularly favorable state of stress is created, with a compressive stress being present on average in each second metal sheet 40 in an unloaded state, and a tensile stress being present on average in each second fiber-reinforced polymer layer 41. According to the invention, it is under this state of stress that the stiffening element can demonstrate the desired stiffness and/or other properties already referred to in this application.

In the variant shown in FIG. 3, reinforcing element 4 can then be connected to the skin sheet 11 in order to obtain the skin panel 3 according to the invention. A possible method for achieving this has already been described above. It is preferable in this respect to connect the stiffening elements to one side of the skin sheet 11, preferably the side facing toward the inside (of the aircraft fuselage), as shown in FIG. 1. According to a preferred embodiment of the skin panel according to the invention, the cross-section of the pre-drawn strip-shaped stiffening element is further deformed into a three-dimensional profile. An example of a longitudinal stiffener 4 formed in this way is shown in FIG. 4. The numbering of the parts corresponds with the numbering used in the other figures.

Stiffening elements according to the invention applied on skin sheets of aircraft fuselages and wings increase the bending stiffness of the skin sheets. This makes them more stable with respect to buckling if they are under strain of pressure and forces can be initiated in the skin sheets without them significantly bending locally. The three-dimensional form of the stiffening elements also helps determine the advantages eventually to be achieved. FIG. 5 shows a number of possible stiffening elements 4 in cross-section. FIG. 5(a) shows a so-called leaf stiffener 4 in a one-sided form and FIG. 5(b) shows the same type of stiffener in a two-sided form. With this latter form, the vertical parts of the stiffener—according to the figure—are interconnected (adhesion is the most suitable connecting method for this purpose, but riveting is also possible). FIG. 5(c) shows a so-called C stiffener. If required, this type of stiffener can also be applied in a two-sided form (FIG. 5(d)). Yet another variant is illustrated in FIG. 5(e) showing a hat stiffener. This form is preferably used in wing skins, in view of its high form stability. A skin sheet 11 is generally provided with a number of longitudinal stiffeners 4, that are affixed at a specific intermediate distance in the peripheral direction of the fuselage. This intermediate distance or pitch depends inter alia on the type of aircraft fuselage, but is preferably between 50 and 300 mm, more preferably between 60 and 250 mm, and most preferably between 80 and 200 mm. The dimensions of the longitudinal stiffener 4 according to the invention can also be selected within these wide ranges. Typical heights are preferably between 20 and 130 mm, more preferably between 25 and 100 mm, and most preferably between 30 and 60 mm. The thickness of the longitudinal stiffener 4 according to the invention is preferably between 0.6 and 10 mm inclusive, more preferably between 0.8 and 5 mm, and most preferably between 0.8 and 3 mm. The curvature radius R under which two legs of the longitudinal stiffener run (see FIG. 5(a) for the definition of the curvature radius) must in principle be as small as possible, preferably being between 1 and 8 mm, more preferably between 2 and 6 mm, and most preferably between 3 and 5 mm.

A longitudinal stiffener according to the invention can be produced in many ways. For instance it is possible to form the longitudinal stiffener out of flat sheet material, by folding, squaring, setting and swivel-bending this material at a suitable temperature using a molding tool, or subjecting it to a corresponding process. In doing so, it is not always possible to make the bending radius of a folded seam sufficiently small. A small bending radius is generally favorable for the stability of the longitudinal stiffener under a compressive load. The longitudinal stiffener according to the invention can also be structured out of more than one extrusion profile or already pre-formed sheet parts. In this method, relatively flat strips having fibers in the longitudinal direction of the stiffener are squared into a three-dimensional profile. To prevent damage occurring to the outermost metal sheets and/or fiber-reinforced polymer layers of the stiffener, a minimum bend radius is preferably taken into consideration. For instance, for a fiber metal laminate with two 2024-T3 aluminum layers that are 0.4 mm thick having a PBO-fiber epoxy layer in-between, this bend radius is taken as approximately equal to 4 mm. The greater the thickness of the fiber metal laminate of the stiffener, the greater the minimum required bend radius. A preferred method in this respect comprises separately deforming several strips of the second fiber metal laminate, for example in the “2/1 configuration” shown in FIG. 1 (1 fiber-reinforced polymer layer between 2 metal sheets) into Z stiffeners, for example by folding or squaring. The Z stiffeners obtained in this way are then adhered together, so that a stiffener having the desired thickness is created. This is then connected to the skin sheet by means of adhesion using an adhesive film and/or a fiber-reinforced polymer having a reduced fiber volume content and/or by means of riveting. A particularly advantageous skin panel according to the invention is obtained by connecting a single or possibly two Z stiffeners made of fiber metal laminate in a 2/1 configuration to the skin sheet thereof, which preferably comprises metal sheets having a thickness of between 0.4 mm and 0.7 mm in this embodiment. Because the thickness of the metal sheets is slightly greater than usually applied in the prior art, an advantage is achieved in terms of production speed, without this jeopardizing the features.

Another preferred method for producing a longitudinal stiffener according to the invention comprises stacking the desired number of (strip-shaped) metal sheets and intermediary fiber-reinforced polymer layers. This stack is shaped into the desired three-dimensional form in an uncured or only partially cured state, for example by means of roll forming known per se. The package formed in this way is then cured in a mold having the form of the longitudinal stiffener. After curing, the stiffener according to the invention is drawn as already discussed in detail above.

Wherever reference is made in the description and claims to the modulus of elasticity, tensile strength and elongation at break of the fibers, they are understood to mean the values under tensile load in the longitudinal direction of the fiber and are determined via measurements on the completed laminate. Within the scope of the invention, various changes can be incorporated. Although metal sheets of the same thickness are firstly applied in the skin sheet according to the invention, it is in principle also possible to apply metal sheets having two or more different thicknesses in one and the same laminate in a possibly symmetrical stack. In general, the thickness of the polymer layer between two consecutive metal sheets in the stiffening element will approximately be of the same size order as that of each of the metal sheets. If desired, the stiffening elements can furthermore demonstrate a tapering thickness as well as a tapering depth.

1-29. (canceled)

30. A skin panel for an aircraft comprising a laminate of at least one first metal sheet, wherein the skin panel is connected to at least one stiffening element, the stiffening element comprising a laminate of second metal sheets and second fiber-reinforced polymer layers connected thereto, wherein the second fiber-reinforced polymer layers including fibers having a modulus of elasticity in tension of greater than 110 GPa.

31. The skin panel of claim 30 wherein the laminate comprises at least one first fiber-reinforced polymer layer connected to the at least one metal sheet.

32. The skin panel of claim 30 wherein the second fiber-reinforced polymer layers include fibers having a modulus of elasticity in tension of greater than 140 GPa.

33. The skin panel of claim 30 wherein the second fiber-reinforced polymer layers include fibers having a modulus of elasticity in tension of greater than 250 GPa.

34. The skin panel of claim 30 wherein the second fiber-reinforced polymer layers include fibers selected from the group consisting of aromatic polyamides (aramids), boron, poly(p-phenylene-2,6-benzobisoxazole) (PBO), and/or M5 fibers.

35. The skin panel of claim 30 wherein when the stiffening element is in an unloaded state, a compressive stress is present on average in each second metal sheet and a tensile stress is present on average in each second fiber-reinforced polymer layer.

36. The skin panel of claim 35 wherein the stiffening element is obtained by:
connecting at least two second metal sheets to at least one intermediary second fiber-reinforced polymer layer to produce a strip-shaped structure; and
forming the strip-shaped structure into a three-dimensional profile,
wherein an elongation is imposed in a lengthwise direction on the strip-shaped structure, such elongation being greater than an elastic elongation of the metal sheets and less than an elongation at break of the fiber-reinforced polymer layer.

37. The skin panel of claim 35 wherein the stiffening element is obtained by:
connecting at least two second metal sheets to at least one intermediary second fiber-reinforced polymer layer to produce a strip-shaped structure,
subjecting the strip-shaped structure to an elongation in a lengthwise direction, such elongation being greater than an elastic elongation of the metal sheets and less than an elongation at break of the fiber-reinforced polymer layer, and
forming the strip-shaped structure into a three-dimensional profile.

38. The skin panel of claim 30 wherein the second fiber-reinforced polymer layers comprise fibers having a ratio of a modulus of elasticity in compression to a modulus of elasticity in tension of less than 0.8.

39. The skin panel of claim 30 wherein the second fiber-reinforced polymer layers comprise fibers having a ratio of a modulus of elasticity in compression to a modulus of elasticity in tension of less than 0.6.

40. The skin panel of claim 30 wherein the second fiber-reinforced polymer layers comprise fibers having a ratio of a modulus of elasticity in compression to a modulus of elasticity in tension of less than 0.4.

41. The skin panel of claim 30 wherein the at least one stiffening element is connected to the laminate by at least one fiber-reinforced polymer layer having a reduced fiber volume content of at most 45 volume-%.

42. The skin panel of claim 30 wherein the at least one stiffening element is connected to the laminate by at least one fiber-reinforced polymer layer having a reduced fiber volume content of at most 39 volume-%.

43. The skin panel of claim 30 wherein the at least one stiffening element is connected to the laminate by at least one fiber-reinforced polymer layer having a reduced fiber volume content of at most 34 volume-%.

44. The skin panel of claim 30 wherein the at least one stiffening element is connected to the laminate by at least one fiber-reinforced polymer layer having a reduced fiber volume content of at most 30 volume-%.

45. The skin panel of claim 31 wherein the first fiber-reinforced polymer layers substantially comprises two groups of continuous fibers extending in parallel and running substantially perpendicular to each other.

46. The skin panel of claim 30 wherein the laminate comprises first metal sheets having a thickness of between 0.6 and 0.8 mm inclusive.

47. The skin panel of claim 30 wherein the metal of at least a part of the metal sheets comprises an aluminum-lithium alloy, aluminum-magnesium-scandium alloy or combinations thereof.

48. The skin panel of claim 30 wherein the metal of at least a part of the metal sheets is selected from the group consisting of aluminum-zinc and aluminum-copper alloys.

49. The skin panel of claim 31 wherein the first fiber-reinforced polymer layer comprises fibers selected from the group of aromatic polyamides (aramids), carbon, boron, poly(p-phenylene-2,6-benzobisoxazole) (PBO), and/or M5 fibers.

50. An aircraft or spacecraft comprising:
a fuselage having a skin panel that includes a laminate having at least one first fiber-reinforced polymer layer connected to at least one first metal sheet, wherein the skin panel is connected to at least one stiffening element comprising a laminate of second metal sheets and second fiber-reinforced polymer layers connected thereto, the second fiber-reinforced polymer layers including fibers having a modulus of elasticity in tension of greater than 110 GPa.

51. The aircraft or spacecraft of claim 50 wherein the skin panel is applied such that fibers of the first fiber-reinforced polymer layer extend substantially in a peripheral direction of the fuselage, and fibers of the second fiber-reinforced polymer layer extend substantially in a longitudinal direction of the fuselage.

52. The aircraft or spacecraft of claim 50 wherein the fuselage comprises a framework of stiffening elements extending in a longitudinal direction of the fuselage and stiffening elements extending in a peripheral direction of the fuselage.

53. The aircraft or spacecraft of claim 52 wherein stiffening elements extending in the longitudinal direction of the fuselage have a three-dimensional profile, and stiffening elements extending in the peripheral direction of the fuselage are strip-shaped.
